(19) United States
(12) Patent Application Publication
(10) Pub. No.: US 2002/0041396 A1
(43) Pub. Date: Apr. 11, 2002

(54) Storage medium control apparatus, image forming apparatus using the same, and control method therefor

(75) Inventors: Atsushi Ugajin, Ebina-shi (JP); Hirokazu Tsubota, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 09/949,766

(22) Filed: Sep. 12, 2001

(30) Foreign Application Priority Data
Oct. 6, 2000 (JP) 2000-307074

(51) Int. Cl. B41F 1/00; G06K 1/00

(52) U.S. Cl. 358/1.17

(57) ABSTRACT

A hard disk is divided into a plurality of regions each having a plurality of sectors, and then writing/reading operations is performed on image data by units of the regions.

### BACKGROUND OF THE INVENTION

1. Field of the Invention

The present invention generally relates to a storage medium control apparatus typified by a disk control apparatus, such as a hard disk control apparatus, an optical disk control apparatus, and the like, and to an image forming apparatus using this control apparatus, and to a control method for such apparatus. More particularly, the invention relates to a storage medium control apparatus enables to stabilize a data transfer time even when a bad storage region, for example, a bad sector is included in a storage medium, such as a disk, and also relates to an image forming apparatus using this control apparatus, and to a control method for such apparatus.

2. Description of the Related Art

An Image forming apparatus of recent years are adapted to store original image data, which is read from an input apparatus, such as a scanner, in a bulk memory, such as a hard disk, and to sort, rearrange the stored data and to then output the sorted or rearranged data therefrom.

Printing speed of such image forming apparatus increases year by year. It can be said that among various factors, a data transfer speed of hard disks affects the printing speed.

However, generally, a hard disk includes a bad sector, on which data read/write cannot normally be performed because of micro defects formed on a storage medium. Such bad sector is a main cause of reduction in the transfer speed of the hard disk.

This bad sector is generated in a process of manufacturing the storage medium. Moreover, during the hard disk is used, the bad sector is generated by an external strong impact, for example, a contact between a head and a medium.

Further, such bad sector is sometimes in a state in which data read/write cannot be performed thereon at all. Alternatively, the bad sector is in a preliminary condition before the bad sector is brought into such state. In this condition, data read/write operation cannot be completed by being tried once to do so. Many retries are performed. In some cases, this is a principal factor in reducing the data transfer speed of the hard disk.

In the case that the data read/write operation cannot be completed at all, the use of an alternate sector is performed as the function of the hard disk. Apparently, this eliminates the inconvenience due to the presence of the bad sector. On the other hand, the use of an alternate sector deteriorates consecutiveness of sectors. Thus, when the number of alternate sectors increases, for example, an increase in the movement distance of a seek head results in decrease in the transfer speed of the hard disk.

Further, when the retry of data read/write operations is repeated, the transfer speed is reduced to a fraction thereof.

Meanwhile, the following conventional techniques have been known.

For instance, JP-A-9-214710 relates to techniques for dividing a storage region of a hard disk. More particularly, this publication discloses a technique for managing transferred data as 1 block. This technique has a merit in wastelessly using free areas in the storage region of the hard disk when data is written thereto. However, there is a fear that when the written data are read, the remaining free areas are provided like vermiculated portions in the storage region according to the order in which the read data are outputted, and that storage capacity needed for writing image data in next time to the storage region cannot be reserved thereon.

Further, JP-A-9-186833 discloses techniques for determining according to a termination status returned from a hard disk whether or not a sector is bad, and for reliably detecting a bad sector by inhibiting error correction processing and error retry processing in the hard disk when it is checked whether or not the hard disk includes the bad sector.

Moreover, JP-A-9-200413 discloses techniques for warning, before an image forming apparatus is disabled from normally performing an image forming operation, a user that defective parts included in a mass storage means increase to an extent that the image forming apparatus is almost hindered from normally performing an image forming operation, and for enabling the user to perform a proper action, such as repair and replacement of the hard disk.

However, a hard disk manufacturer's criterion for judgment on a “bad sector” is supposed to differ from a user's (or customer's) criterion therefor. Further, although the error retry processing may be inhibited by a command, actually, this processing is sometimes inhibited in a hard disk.

Thus, “bad sectors to be determined by users” are not sufficiently detected.

As described above, when the bad sector is included in the hard disk for storing the image data, the data transfer speed thereof is low in the conventional image forming apparatus.

### SUMMARY OF THE INVENTION

Accordingly, an object of the invention is to provide a storage medium control apparatus enabling to eliminate the disadvantage of the conventional apparatus and to stabilize a data transfer time even when a bad storage region, for example, a bad sector is included in a storage medium, such as a disk. Another object of the invention is to provide an image forming apparatus using such storage medium control apparatus. Still another object of the invention is to provide a control method for these apparatus.

To achieve the foregoing objects, according to a first aspect of the invention, there is provided a storage medium control apparatus comprising a control section adapted to control a data writing/reading operation to/from a storage medium,

wherein the storage medium is divided into a plurality of storage regions each having a predetermined storage amount;

the control section defines a plurality of units of management, by each of which the data writing/reading operation is performed;

each of units of management has predetermined number of the storage regions being sequential physically; and a storage amount of the predetermined number of the storage regions is an amount of predetermined data to be stored physically-sequentially in the storage medium.

With this configuration, the data write/read operations are controlled by employing the plurality of storage regions, which are sequential physically and have a storage amount corresponding to an amount of data to be stored in the storage medium (for example, corresponding to one page of a maximum sheet size), as the unit of management. This secures the continuity of a data transfer.

Further, according to a second aspect of the invention, there is provided the storage medium control apparatus according to the first aspect of the invention, wherein when a defective storage region is detected from one of the units of management, the control section inhibits use of the one of the units of management.

Moreover, according to a third aspect of the invention, there is provided the storage medium control apparatus according to the first aspect of the invention, wherein when a time taken to write/read data to/from one of storage units of management is not shorter than a predetermined time, the control section inhibits use of the one of the units of management.

With each of these configurations according to the second and third aspects of the invention, the control section inhibits the use of the unit of management when a defective region is detected from the units of management. Thus, a stable data transfer time is ensured.

According to a fourth aspect of the ivention, there is provided the storage medium control apparatus according to any one of the first to third aspects of the invention, wherein the storage medium is a disk; and the storage regions are sectors.

According to a fifth aspect of the invention, there is provided an image forming apparatus comprising a control section adapted to control an image data writing/reading operation to/from a storage medium,

wherein the storage medium is divided into a plurality of storage regions each having a predetermined storage amount;

the control section defines a plurality of units of management, by each of which the image data writing/reading operation is performed;

each of units of management has predetermined number of the storage regions being sequential physically; and a storage amount of the predetermined number of the storage regions is an amount of predetermined image data to be stored physically-sequentially in the storage medium.

According to a sixth aspect of the invention, there is provided the image forming apparatus according to the fifth aspect of the invention, wherein the predetermined image data is one page of a minimum image data.

With this configuration, the data write/read operations are performed on the units of management by units of at least one page of minimum image data. Thus, the image data of one page is necessarily stored in the unit of management, that is, the plurality of physically sequential regions. Consequently, a data transfer time at each data write/read is stabilized.

According to a seventh aspect of the invention, there is provided the image forming apparatus according to the fifth aspect of the invention, wherein the predetermined image data is one page of a maximum image data being handled.

With this configuration, the data write/read operations are performed on the units of management by units of one page of maximum image data to be handled. Thus, the image data of one page is necessarily stored in the units of management, that is, the plurality of physically sequential regions. Consequently, a data transfer time at each data write/read is stabilized.

According to an eighth aspect of the invention, there is provided the image forming apparatus according to any one of the fifth to seventh aspects of the invention, further comprising a monitoring section adapted to monitor a status of generation of a defective storage regions in each of units of management.

According to a ninth aspect of the invention, there is provided the image forming apparatus according to the eighth aspect of the invention, wherein the monitoring section obtains the status of generation of defective storage regions in each of units of management from the storage medium to perform monitoring.

According to a tenth aspect of the invention, there is provided the image forming apparatus according to the eighth aspect of the invention, wherein when the status of generation of defective storage regions in one of the units of management meets a predetermined condition, the control section inhibits use of the one of the units of management.

According to an eleventh aspect of the invention, there is provided the image forming apparatus according to the tenth aspect of the invention, wherein the predetermined condition is that the number of the defective regions in the one of the units of management is not smaller than a predetermined number.

According to a twelfth aspect of the invention, there is provided the image forming apparatus according to the tenth aspect of the invention, wherein the predetermined condition is that the number of times of retry accesses to the one of the units of management is not smaller than a predetermined number of times.

According to a thirteenth aspect of the invention there is provided the image forming apparatus according to the tenth aspect of the invention, wherein the predetermined condition is that one of a time taken to read the image data from the one of the units of management and a time take to write the image data from the one of the units of management is not shorter than a predetermined time.

According to a fourteenth aspect of the invention, there is provided the image forming apparatus according to the thirteenth aspect of the invention, further comprising an image forming section adapted to form an image on a paper based on the image data,

wherein the predetermined time is a time taken to form the image on the paper by the image forming section.

According to a fifteenth aspect of the invention, there is provided the image forming apparatus according to any one of the fifth to fourteenth aspects of the invention, wherein the storage medium is a hard disk; and the storage region is a sector.

With this configuration, the data write/read operations are performed on the units of management by the units of one page of minimum image data. Thus, the image data of one page is necessarily stored in the units of management, that is, the plurality of physically sequential regions. Hence, an amount of movement of a hard disk head is reduced. Consequently, a data transfer time at each data write/read is stabilized.

According to a sixteenth aspect of the invention, there is provided the image forming apparatus according to any one of the fifth to fifteenth aspects of the invention, the image forming apparatus further comprising:

an image inputting section adapted to input an image data before compressed;

an image quality condition inputting section for adapted to input image quality condition including high image quality condition; and

a compression control section adapted to apply compression processing, which includes non-compression, to the image data before compressed on a basis of the image quality condition,

wherein the compression-processed image data is written to the storage medium; and

in case of the high image quality condition, the compression control section performs non-compression or reversible-compression.

With this configuration, the image quality of an image is prevented from being deteriorated contrary to a user's intention.

According to a seventeenth aspect of the invention, there is provided the image forming apparatus according to the sixteenth aspect of the invention, a notifying section adapted to notify the user of information,

wherein when an amount of the compressed image data is not smaller than a predetermined amount, the notifying section notifies the user of the amount of the compressed image data being not smaller than the predetermined amount.

This enables the apparatus to show such physical limitations to users. Consequently, this permits users to perform image processing by interacting with the apparatus.

According to a eighteenth aspect of the invention, the image forming apparatus according to the seventeenth aspect of the invention, wherein the predetermined amount is an amount of one page of a minimum image data.

According to a nineteenth aspect of the invention, there is provided the image forming apparatus according to the seventeenth aspect of the invention, wherein the predetermined amount is an amount of one page of a maximum image data to be handled.

According to a twentieth aspect of the invention, there is provided the image forming apparatus according to the seventeenth aspect of the invention, wherein the predetermined amount is a remaining amount of the storage medium.

With these configurations, the image quality of an image is prevented from being deteriorated contrary to a user's intention.

According to a twenty-first aspect of the invention, there is provided a storage medium control method for controlling data writing/reading operations to/from a storage medium adapted to store data by units of storage regions having a predetermined storage amount, the method comprising the steps of:

defining a plurality of units of management having predetermined number of the storage regions being sequential physically; and

performing the data writing/reading operation by the units of management,

wherein an amount of the predetermined number of the storage regions is an amount of predetermined data to be stored physically-sequentially in the storage medium.

With this configuration, the data write/read operations are controlled by employing the plurality of storage regions, which are physically sequential regions, as a unit of management.

Preferably, the method according to the twenty-first aspect of the invention is adapted so that when a defective storage region is detected from the plurality of storage regions employed as the units of management, the use of the plurality of physically sequential storage regions is inhibited.

Further, preferably, the method according to the twenty-first aspect of the invention is adapted so that when a time taken to write data to or to read data from the unit of management is longer than a predetermined time, the use of the unit of management is inhibited. With each of these configurations, when a defective storage region is detected from the plurality of physically sequential storage regions employed as the units of management, the use of the units of management is inhibited. Thus, a stable data transfer time is ensured.

Further preferably, in the method according to the twenty-first aspect of the invention, the storage medium is a hard disk and the storage region is a sector.

According to a twenty-second aspect of the invention, there is provided an image forming apparatus control method for controlling image data writing/reading operations to/from a storage medium adapted to store data by units of storage regions having a predetermined storage amount, the method comprising the steps of:

defining a plurality of units of management having predetermined number of the storage regions being sequential physically; and

performing the data writing/reading operation by the units of management,

wherein an amount of the predetermined number of the storage regions is an amount of predetermined image data to be stored physically-sequentially in the storage medium.

With this method, the image data of one page is necessarily stored in the unit of management, that is, the plurality of physically sequential regions. Consequently, a data transfer time at each data write/read is stabilized.

According to a twenty-third aspect of the invention, there is provided the method according to the twenty-second aspect of the invention, wherein the predetermined image data is one page of a minimum image data.

According to a twenty-fourth aspect of the invention, there is provided the method according to the twenty-second aspect of the invention, further comprising the steps of:

inputting image data before compressed;

inputting a compression condition;

applying compression process to the image data before compressed on a basis of the compression condition; and

storing the compressed image data in the storage medium.

Further, preferably, in the method according to the twenty-second aspect of the invention, the predetermined image data is one page of maximum image data to be handled. With this configuration, the data write/read operations are performed on the storage regions obtained by dividing the storage medium by units of one page of maximum image data to be handled. Thus, image data of one page is necessarily stored in the storage regions, which are obtained by dividing the storage medium, that is, physically sequential regions. Consequently, a data transfer time at each data write/read is stabilized.

Moreover, preferably, the method according to the twenty-second aspect of the invention further comprises the step of monitoring a status of generation of a defective storage unit region in the unit of management.

Furthermore, preferably, the step of monitoring comprises the steps of: detecting the places, at which each of the defective storage regions is generated, and the number of the generated defective storage regions by obtaining information from the storage medium; and inhibiting the use of the unit of management when predetermined conditions are met.

Preferably, this predetermined condition relates to the number of the defective storage regions.

Preferably, the predetermined condition relates to a predetermined value of the number of retries of access to the unit of management.

Furthermore, preferably, the step of monitoring comprises the step of inhibiting the use of the unit of management when a time taken to write data to the storage area or taken to read data therefrom is equal to or longer than a predetermined time.

Preferably, this predetermined condition is that a time taken to read data recorded in the unit of management is equal to or longer than a time taken to form an image.

Further, preferably, the predetermined condition is that a time taken to write data recorded in the unit of management is equal to or longer than a time taken to form an image. With these configurations, the apparatus is enabled to monitor a status of generation of a defective storage region in each of units of management. Moreover, according to a result of the monitoring, the apparatus ensures a more stable data transfer time.

Furthermore, according to the methods of the invention, the storage medium is a disk, and the storage regions are sectors. With this configuration, the data write/read operations are performed on the units of management by the units of one page of minimum image data. Thus, image data of one page is necessarily stored in the unit of management, that is, the plurality of physically sequential regions. Hence, the amount of movement of each of a hard disk head is reduced. Consequently, a data transfer time is stabilized.

Preferably, the method according to the twenty-second aspect of the invention further comprises the step of recording, when formation of a high-image quality image is designated, the input image data on a recording medium without being compressed or after reversible compression is performed on the input image data. With this method, the image quality of an image is prevented from being deteriorated contrary to a user's intention.

Moreover, preferably, the method according to the twenty-second aspect of the invention further comprises the step of notifying, when a storage amount needed for recording the input image data is less than a predetermined storage amount, a reason why the image data is not recorded on the recording medium. This method can show such physical limitations to users. Consequently, this permits users to perform image processing by interacting with the apparatus.

In this case, preferably, the predetermined storage capacity is equal to a storage amount of minimum image data of one page secured on the recording medium.

Alternatively, the predetermined storage capacity is equal to a storage amount of maximum image data of one page to be processed, which is secured on the recording medium.

Furthermore, alternatively, the predetermined storage capacity is determined so as to determine whether or not a free physical storage area of the recording medium is sufficient for storing the input image data.

With these methods, the image quality of an image is prevented from being deteriorated contrary to a user's intention.

In a twenty-fifth aspect of the invention, there is provided an image forming apparatus for converting image data obtained by reading with an image reading section into a plurality of image data consisting of a plurality of colors and for performing image formation, the image forming apparatus comprising a compression control section, in case that the image formation with high image quality is instructed, adapted to non-compressing or reversibly compressing the image data obtained by reading the image reading section to save the non-compressed or reversibly compressed image data in a record medium.

In a twenty-sixth aspect of the invention, there is provided the image forming apparatus according to the twenty-fifth aspect of the invention, further comprising a notifying section adapted to notify a reason in case that the image data by the compression control section is larger than a predetermined amount.

### BRIEF DESCIRPTION OF THE DRAWINGS

FIG. 1 is a diagram illustrating configuration of an image forming system to which a tandem color image forming apparatus according to the invention is applied.

FIG. 2 is a schematic block diagram illustrating system configuration of the tandem color image forming apparatus shown in FIG. 1.

FIG. 3 is a block diagram illustrating detailed system configuration of the tandem color image forming apparatus shown in FIG. 2.

FIG. 4 is a flowchart illustrating an outline of procedure for performing concurrent processing.

FIG. 5 is a reference diagram to be referred to the flowchart shown in FIG. 4.

FIG. 6 is a diagram illustrating configuration of the HDD shown in FIG. 3.

FIG. 7 is a diagram illustrating configuration of information regions in an image data information management table for storing information on image data stored in the HDD illustrated in FIG. 6.

FIG. 8 is a diagram illustrating configuration of data stored in the page information region of the image data management table illustrated in FIG. 7.

FIG. 9 is a diagram illustrating configuration of data stored in the error information region of the image data management table illustrated in FIG. 7.

FIG. 10 is a time chart illustrating a time between activation of HDD and generation of an interrupt signal.

FIG. 11 is a flowchart illustrating a procedure for writing compressed image data to block #0 of the HDD shown in FIG. 6.

FIG. 12 is a flowchart illustrating a procedure for performing image data compression processing so as to enable blocks of the HDD shown in FIG. 6 to store image data of one page of an original.

FIG. 13 is a flowchart illustrating a procedure for performing, when a user requests high image quality, compression processing by using reversible compression.

FIG. 14 is a diagram illustrating a modification of the image forming system shown in FIG. 1.

### DETAILED DESCRIPTION OF THE PREFERRED EMBODIMENTS

Hereinafter, an embodiment of the invention is described in detail by referring to the accompanying drawings.

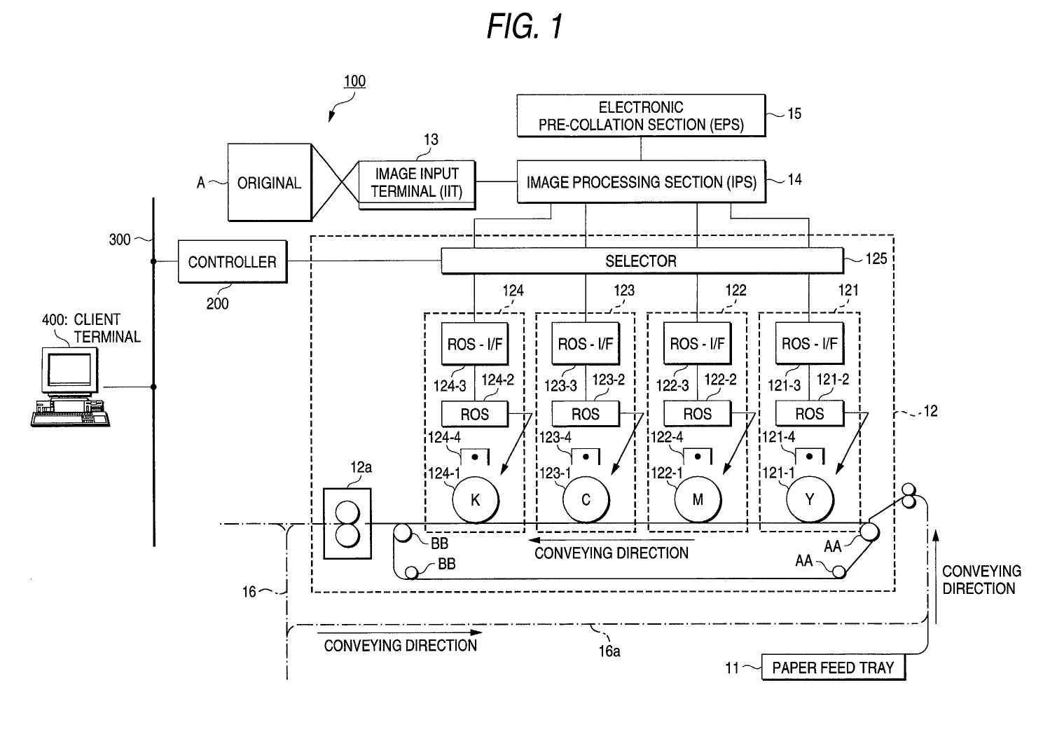

FIG. 1 is a diagram illustrating configuration of an image forming system to which a tandem color image forming apparatus 100 according to the invention is applied.

As shown in FIG. 1, the tandem color image forming apparatus 100 of the image forming system comprises a paper feed tray 11 adapted to accommodate printing paper, an image output terminal (hereunder referred to simply as “IOT”) 12 for forming images corresponding to four colors, respectively, that is, Cyan (C), Magenta (M), Yellow (Y), and Black (B) on the fed paper, an image input terminal (hereunder referred to simply as “IIT”) 13 for reading image data from an original A, an image processing system (hereunder referred to simply as “IPS”) 14 for performing predetermined image processing (for instance, color space conversion processing, color correction processing, edit processing, resolution conversion processing, rotation processing, and compression/expansion processing) on the image data from the IIT 13, an electronic pre-collation portion (hereunder referred to simply as “EPC”) 15 for sorting print image data, and a paper conveying path 16 for supplying paper to the IOT 12 and for conveying paper to be used for duplex printing and multiple printing. Incidentally, two sets of conveying rollers AA and BB are provided in a double side path portion 16a of the paper conveying path 16 in such a way as to be arranged along conveying direction of a paper 1.

The IOT 12 has a fixing portion 12a for applying heat and pressure to the paper 1 and for fixing a toner image on this paper 1.

The paper conveying path 16 has the double side path portion 16a for conveying the paper 1, on which an image is formed at the IOT 12, to the IOT 12 again so as to perform the duplex printing and the multiple printing.

Further, the IOT 12 has image forming units, which correspond to the colors Y, M, C, and K, respectively. That is, a yellow image forming unit 121 for forming a yellow (Y) image, a magenta image forming unit 122 for forming a magenta (M) image, a cyan image forming unit 123 for forming a cyan (C) image, and a black image forming unit 124 for forming a black (K) image. These four image forming units 121 to 124 are disposed at uniform intervals in a horizontal direction.

Furthermore, these four image forming units 121 to 124 are constructed in such a way as to be of the same configuration. In these image forming units, a yellow toner image, a magenta toner image, a cyan toner image, and a black toner image are formed in sequence.

The image forming units 121 to 124 have photosensitive drums 121-1 to 124-1, respectively. Surfaces of the photosensitive drums 121-1 to 121-4 are uniformly charged by a scorotron, which serves as a primary charger. Thereafter, the surfaces of the photosensitive drums 12-1 to 121-4 are scanned and exposed with laser light beams, which are used for image formation, by image exposing devices (namely, raster output scanning devices (ROSs)) 121-2 to 124-2 according to image data transferred from the IPS 14 through ROS-I/Fs 121-2 to 124-2 and the selector 125. Thus, electrostatic latent images are formed thereon.

Then, the electrostatic latent images formed on the surfaces of the photosensitive drums 121-1 to 124-1 are developed by developing devices 121-4 to 124-4 of the image forming units 121 to 124, which use yellow, magenta, cyan and black toners, respectively, so that visible toner images are formed. Subsequently, these visible toner images are transferred onto the paper of a transfer member, which is supplied by a conveying belt, in such a manner as to be superimposed on each other.

Thereafter, the color toner images transferred onto the transfer paper by multiple transfer undergo fixing performed by fixing devices 12a. Thus, a color image is formed.

Moreover, this tandem color image forming apparatus 100 has function for communicating with a client terminal (namely, a personal computer (PC)) 400 connected to a network 300 (for example, a LAN circuit) through an external controller portion 200.

Furthermore, the tandem color image forming apparatus 100 of the aforementioned embodiment employs the plurality of colors that are four colors including Cyan (C), Magenta (M), Yellow (Y), and Black (K). The colors employed by the apparatus of the invention are not limited to these four colors. The invention can be applied to an image forming apparatus employing five colors, which are obtained by adding a specific color to the four colors, and which thus has a train of five image forming units, and to another image forming apparatus, which has two series-connected IOTs and thus has a train of eight image forming units. The invention may be also applied to another tandem image forming apparatus that has a train of two drums each corresponding to two colors. Practically, this apparatus is adapted so that one of the drums is supplied with toner corresponding to two colors Y and M, while the other drum is supplied with toner corresponding to other two colors C and K.

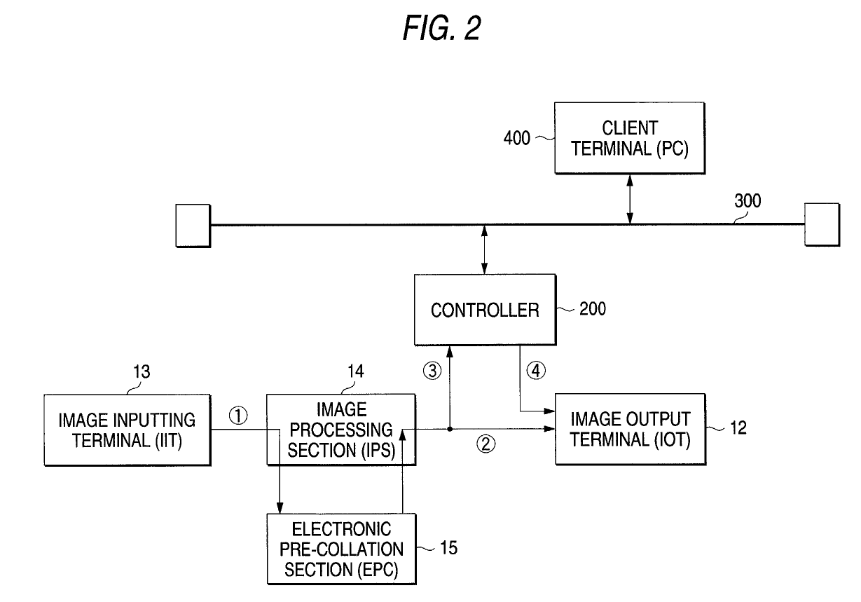

FIG. 2 is a schematic block diagram illustrating the tandem color image forming apparatus shown in FIG. 1.

As illustrated in FIG. 2, rough system configuration of this tandem color image forming apparatus 100 includes the image output terminal (IOT) 12, the image input terminal(IIT) 13, the image processing system (IPS) 14, and the electronic pre-collation portion (EPC) 15.

Further, this tandem color image forming apparatus 100 is connected through an external controller 200 to the client terminal 400, which is connected to a network 300.

(1) shown in FIG. 2 designates a copy scan operation, that is, reading image data of an original by the image input terminal (IIT), and storing the read image data in a storage device, such as HDD, through the image processing system (IPS) under control of the electronic pre-collation portion (EPC) 15. The image input terminal (IIT) may comprise a buffer memory for storing the image data temporarily.

Further, (2) designates an EPC to Print operation (a copy print job), that is, an operation to be performed when the image data, which is obtained by the scan operation (1) and stored in the storage device, such as a hard disk (HDD), is read therefrom to a page buffer and printed.

Moreover, “(1)→(2)” denotes a copy operation, that is, performing a sequence of the operations (1) and (2).

Furthermore, “(1)→(3)” designates a Scan to File operation, that is, an operation of transferring a file of image data, which is read by the image input terminal (IIT), to a printer controller section through the image processing system (IPS) so as to transfer the image data to the client terminal (PC) connected to the network.

Further, (4) designates a print operation (a print job), that is, an operation of causing the image output terminal (IOT) through a printer controller to print the image data according to a print instruction issued by the client terminal (PC) connected to the network.

Incidentally, the operations (2) and (3) are not operated simultaneously. Moreover, the operations (2) and (4) are not operated simultaneously. Further, there are the following four kinds of concurrent processing, that is, an operations (2)+(1) (next job), an operation (3)+(1), an operation (3)+(1)+(4), and an operation (1)+(4).

That is, the concurrent processing (2)+(1) is to perform the copy scan operation concurrently with and during the copy print job is performed.

Further, the concurrent processing (3)+(1) is to perform the copy scan operation concurrently with and during the transfer of an image data file to the client terminal connected to the network.

Moreover, the concurrent processing (3)+(1)+(4) is to perform printing according to the print instruction issued from the client terminal, which is connected to the network, concurrently with and in addition to the above-described operation (3)+(1).

Furthermore, the concurrent processing (1)+(4) is to perform printing (the print job) according to the print instruction issued from the client terminal, which is connected to the network, concurrently with and during the copy scan operation.

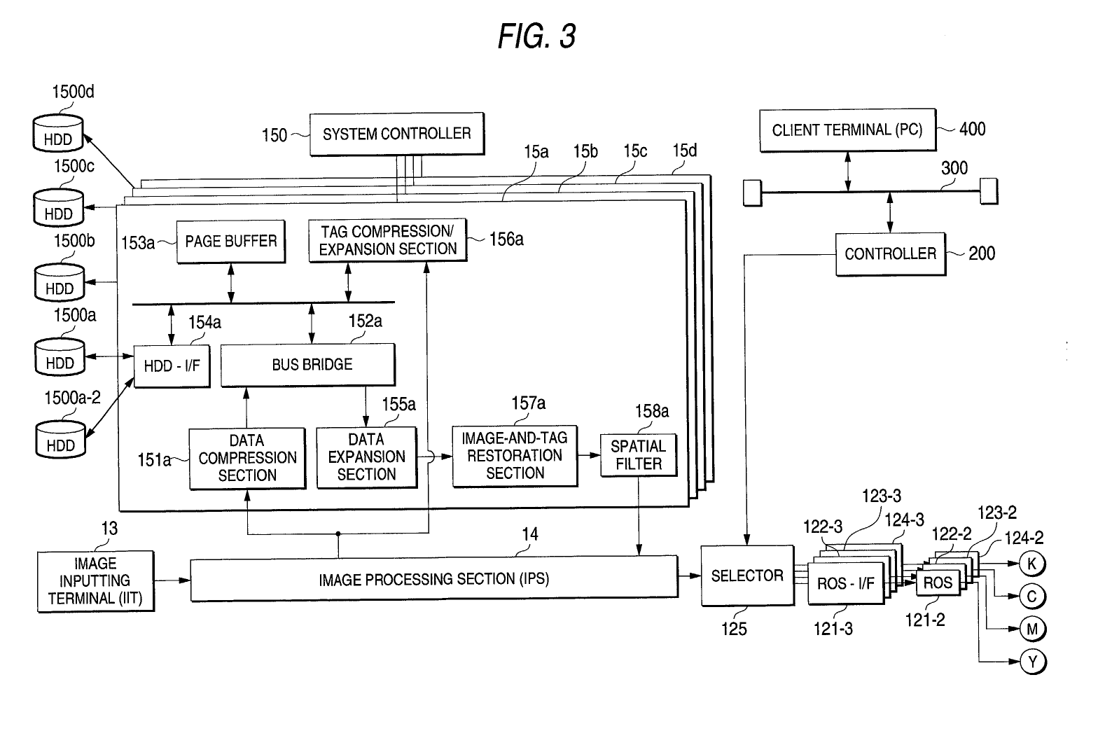

FIG. 3 is a diagram illustrating more detailed system configuration of the tandem color image forming apparatus 100 shown in FIG. 2. FIG. 3 illustrates, especially, the electronic pre-collation portion (EPC) in detail.

As shown in FIG. 3, each of the electronic pre-collation portions (EPC) 15a to 15d comprises a corresponding one of data compression sections 151a to 151d, a corresponding one of bus bridges 152a to 152d, a corresponding one of page buffers 153a to 153d, a corresponding one of HDD interface portions 154a to 154d, a corresponding one of data expansion sections 155a to 155d, a corresponding one of TAG compression/expansion sections 156a to 156d, a corresponding one of image-and-tag restoration sections 157a to 157d, and a corresponding one of spatial filter portions 158a to 158d.

Further, each of the electronic pre-collation portions 15a to 15d is connected to a corresponding one of the hard disks (HDDs) 1500a to 1500d, which store image data corresponding to the colors, respectively, through a corresponding one of the HDD interfaces 154a to 154d. Moreover, as will be described later, in this embodiment of the invention, the EPC section corresponding to Yellow (Y) is connected to a hard disk (HDD) 1500a-2, which stores an image data file to be used for the Scan-to-File operation, in addition to the hard disk (HDD) 1500a for storing image data corresponding to Yellow (Y).

Incidentally, operations of the electronic pre-collation portions (EPCs) 15a to 15d are performed under the control of the system controller 150.

Further, the following description describes a sequence of operations to be performed by this apparatus.

First, a flow of image data processing to be performed at the time of reading image data is described hereinbelow.

Analog RGB image data read by the image input terminal (IIT) 13 is inputted to the image processing system (IPS) 14. Then, predetermined processing at each image input is performed thereon, so that the input image data is converted to four color image data respectively corresponding to the four colors, that is, Y (Yellow), M (Magenta), C (Cyan) and K (Black).

Each of image data corresponding to Y, M, C, and K is sent to a corresponding one of the EPC sections 15a to 15d, which correspond to these colors. Thereafter, in each of the EPC sections 15a to 15d corresponding to Y, M, C, and K, respectively, each of transferred and inputted image data is undergone predetermined compression processing (the corresponding compressibility is 1/5.33) performed by each of data compression sections 151a to 151d. Subsequently, each of image data corresponding to each of the colors is temporarily stored in a corresponding one of the page buffers 153a to 153d through a corresponding one of the bus bridges 152a to 152d. Thereafter, the image data corresponding to each of the colors is stored in a corresponding one of the HDD 1500a to 1500d through a corresponding one of the HDD interfaces 154a to 154d.

Next, a flow of image data processing to be performed at the time of forming an image is described hereinbelow.

When the image is printed, the image data corresponding to each of the colors, which is stored in a corresponding one of the HDDs 1500a to 1500d by the processing performed at the time of reading the image, is read out through a corresponding one of the HDD interfaces 154a to 154d to a corresponding one of the page buffers 153a to 153d. Thereafter, the read out image data corresponding to each of the colors is transferred to a corresponding one of the data expansion sections 155a to 155d through a corresponding one of the bus bridges 152a to 152d. In the data expansion sections 155a to 155d, expansion processing is performed on the image data corresponding to the colors, respectively. Then, a set of the expanded image data, which corresponds to each of colors, and corresponding tag information is restored in a corresponding one of the image-and-tag restoration sections 157a to 157d. Then, predetermined spatial processing is performed on the restored image data, which corresponds to each of colors, in a corresponding one of the spatial filter portions 158a to 158d. Subsequently, the image data corresponding to each of colors is transferred to the image processing system (IPS) 14. Further, predetermined processing to be performed at image output is performed on the image data in the image processing system (IPS) 14. Then, resultant image data is outputted to the image output terminal (IOT) 12. In the image output terminal (IOT) 12, first, the image data corresponding to each of colors is selected. Subsequently, the selected image data is outputted to a corresponding one of the image forming unit portions 121 to 124, which correspond to the colors, respectively. That is, the selected image data corresponding to each of colors is outputted to a corresponding one of the ROS-I/F portions 121-3 to 124-3 and a corresponding one of the ROS portions 121-2 to 124-2.

Thus, each of ROS 121-2 to 124-2 causes image forming laser light to scan each of surfaces of the photosensitive drums 121-1 to 124-1 according to the inputted image data. Then, the scanned surfaces thereof are exposed so that electrostatic latent images are formed thereon.

Incidentally, the number of the storage medium, such as hard disks (HDDs), is determined so that transfer bandwidth (or transfer frequency) corresponding to image data to be printed out is less than transfer bandwidth (or transfer frequency) of the storage medium.

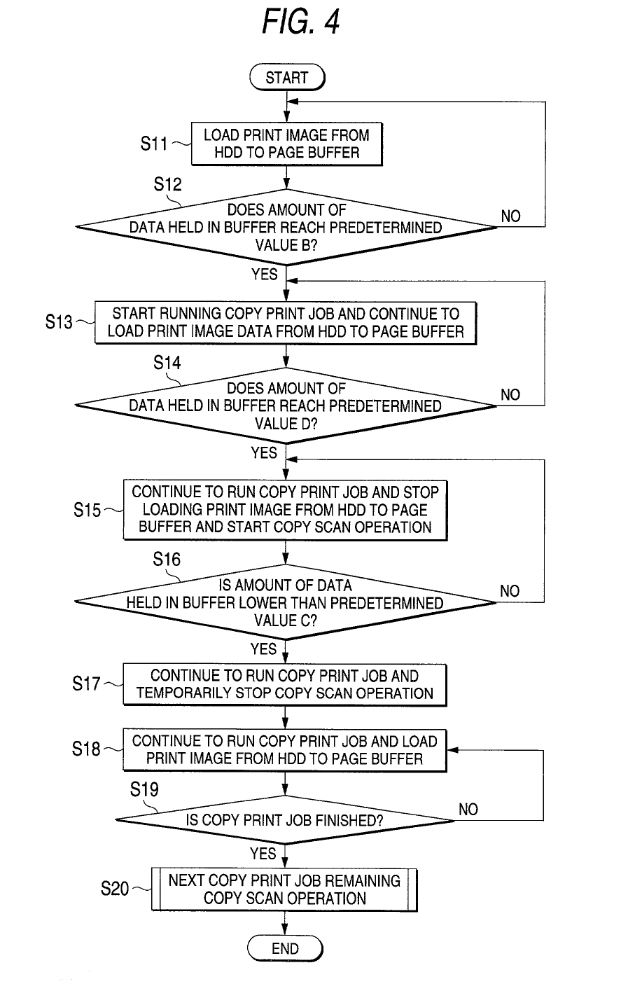

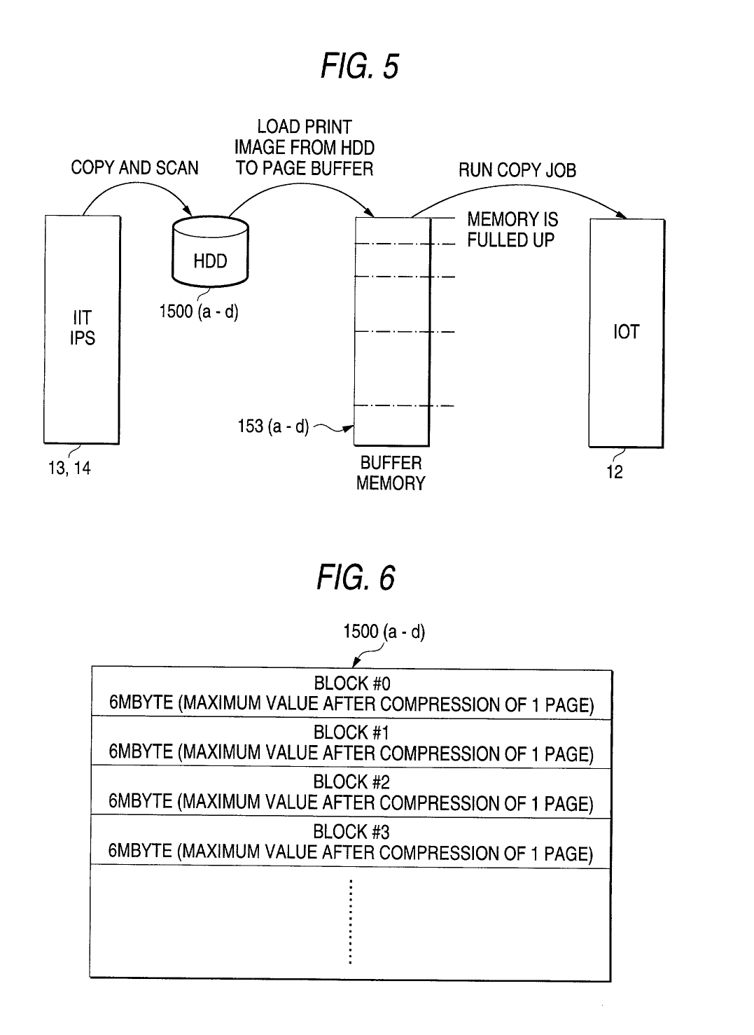

Hereinafter, an outline of the concurrent processing is described with reference to FIGS. 4 and 5.

FIG. 4 is a flowchart illustrating an outline of a procedure for performing the concurrent processing. This flowchart illustrates the concurrent processing (2)+(1), that is, the concurrent processing to be performed in a case of performing the copy scan operation concurrently during performing the copy print job. Further, FIG. 5 is a reference diagram of the flowchart and illustrates a threshold value employed in a buffer memory and a flow of video signals.

As illustrated in FIG. 4, first, print image data is loaded from each of HDDs 1500a to 1500d to each of page buffers 153a to 153d (step S11).

Thereafter, it is decided whether or not an amount of data held in each of the page buffers 153a to 153d reaches a predetermined value B (step S12).

When a result of the decision in step S12 reveals that the amount of data held in each of the page buffers 153a to 153d reaches the predetermined value B (namely, when control exits from step S12 through YES-branch), a copy print job is subsequently started. Moreover, control continues to load the print image data into the page buffers from the HDDs 1500a to 1500d (step S13).

Thereafter, it is decided whether or not the amount of data held in each of the page buffers 153a to 153d reaches a predetermined value D (step S14).

When a result of this decision made in step S14 shows that the amount of data held in each of the page buffers 153a to 153d reaches the predetermined value D (namely, when control exits from step S14 through YES-branch), the copy print job is subsequently continued, while control stops loading the print image data into the page buffers from the HDDs 1500a to 1500d. Then, a copy scan operation is commenced (step S15).

Thereafter, it is determined whether or not the amount of data held in each of the page buffers 153a to 153d is lower than a predetermined value C (step S16).

When a result of this decision made in step S16 shows that the amount of data held in each of the page buffers 153a to 153d is lower than the predetermined value C (namely, when control exits from step S16 through YES-branch), subsequently, the copy print job is continued, while the copy scan operation is temporarily stopped (step S17). Then, in step S18, print image data is loaded from the HDDs 1500a to 1500d into the page buffers 153a to 153d, while the copy print job is continued.

Thereafter, it is decided in step S19 whether or not the copy print job is finished. When a result of this decision made in step S19 indicates that the copy print job is finished (namely, when control exits from step S19 through YES-branch), control proceeds to the next copy print job and the remaining copy scan operation processing in step S20 (if there is the next copy print job, the control proceeds to step S11). Then, this processing is finished.

Incidentally, when a result of the decision made in step S12 shows that the amount of data held in each of the page buffers 153a to 153d does not reach the predetermined value B (namely, when control exits from step S12 through NO-branch), control returns to step S11, and then those similar to the aforementioned operations are performed.

Further, when a result of the decision made in step S14 shows that the amount of data held in each of the page buffers 153a to 153d does not reach the predetermined value D (namely, when control exits from step S14 through NO-branch), control returns to step S13, and then those similar to the aforementioned operations are performed.

Moreover, when a result of the decision made in step S16 shows that the amount of data held in each of the page buffers 153a to 153d is not smaller than the predetermined value C (namely, when control exits from step S16 through NO-branch), control returns to step S15, and then those similar to the aforementioned operations are performed.

Furthermore, when a result of the decision made in step S19 shows that the copy print job is not finished (namely, when control exits from step S19 through NO-branch), control returns to step S18, and then those similar to the aforementioned operations are performed.

Although the threshold values B, C, and D are used as criteria for determining an order of processing jobs in this embodiment, it is not always necessary to set threshold values for the buffer memories. Such decisions may be made according to the number of printed pages.

Incidentally, the invention is effective, especially, in an image forming apparatus adapted to perform the concurrent processing as described above.

Hereinafter, features of this embodiment of the invention are described.

FIG. 6 is a diagram illustrating a layout of data items in each of the HDDs 1500a to 1500d shown in FIG. 3.

As illustrated in FIG. 6, according to this embodiment of the invention, a storage area of each of the HDDs 1500a to 1500d is uniformly divided into storage regions each having storage capacity that is equal to the maximum storage capacity size of compressed image data of one page of an original.

Usually, the maximum storage capacity size of compressed image data of one page of an original is several Mbytes to 6 Mbytes or so. In this embodiment, the compressibility is set so that the amount of compressed data of one page is equal to or less than 6 Mbytes. Further, the storage capacity of each of the storage regions obtained by dividing the storage area is set at 6 Mbytes.

Incidentally, such a storage (unit) region is hereunder referred to as a block.

Further, in this embodiment of the invention, the storage amount of such a storage unit region is equal to at least a data amount of minimum image data of one page, or to a data amount of one page of maximum image data to be treated.

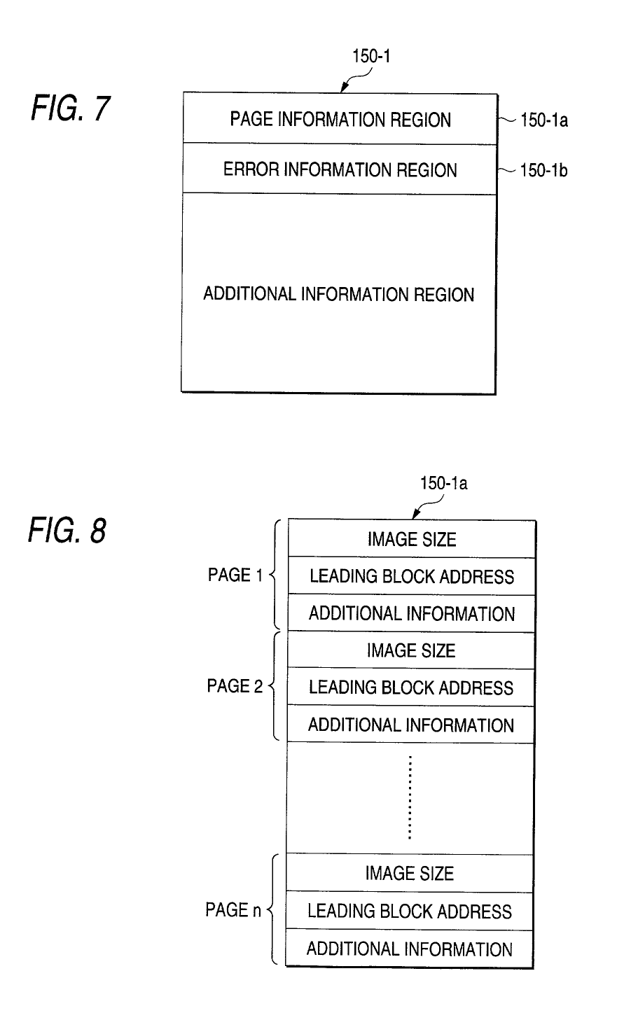

FIG. 7 is a diagram illustrating a layout of an image data information management table 150-1 for storing information on image data stored in each of the HDDs 1500a to 1500d illustrated in FIG. 6. Incidentally, this image data information management table 150-1 is stored in, for instance, a nonvolatile memory.

As shown in FIG. 7, this image data management table 150-1 comprises a page information region 150-1a for storing page information, an error information region 150-1b for storing error information, and an additional information region for storing additional other kinds of information. The additional other kind of information is, for example setting for print output.

FIG. 8 is a diagram illustrating a layout of data stored in the page information region 150-1a of the image data management table 150-1 shown in FIG. 7.

As shown in FIG. 8, this page information region 150-1a is constructed to comprise an image size area for storing information indicating an image size, a leading block address area for storing information representing the leading address of the block, and an additional information area for storing other kinds of information on the image data for every page of image data of an original, which is stored in each of blocks (see FIG. 6) of the HDDs 1500a to 1500d. The other kind of information is, for example, package information of image data.

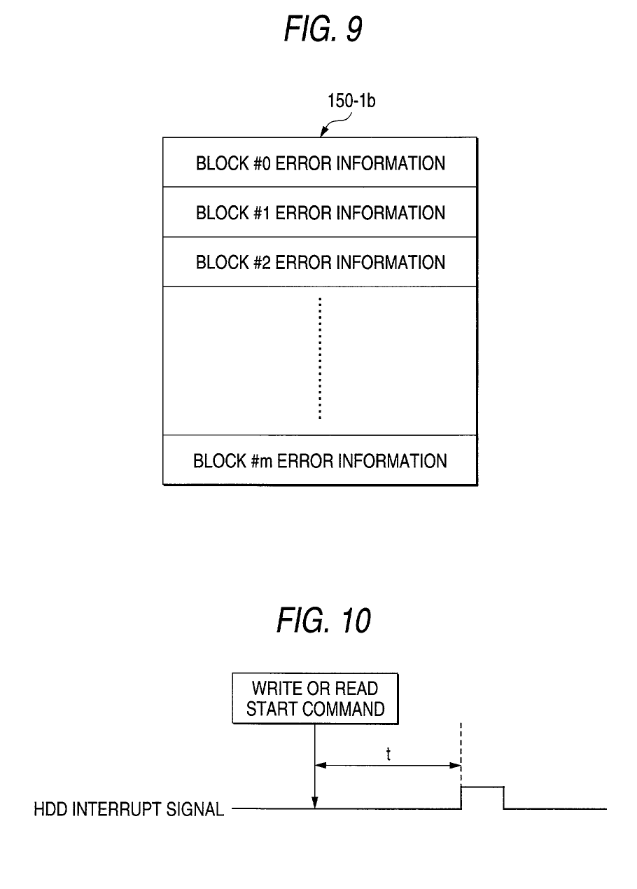

FIG. 9 is a diagram illustrating a layout of data stored in the error information region 150-1b of the image data management table 150-1 shown in FIG. 7.

As illustrated in FIG. 9, this error information region 150-1b is constructed to have a block error information area for storing error information on each of the blocks of the HDDs 1500a to 1500d shown in FIG. 6, that is, information representing whether or not each of the blocks is defective. When some block of the HDDs 1500a to 1500d is defective, that block is registered in the block error information area. The error information may be registered so that when a corresponding block is normal, the information designates “0”, and that when the corresponding block is defective, the information represents “1”.

Next, a defective block management method of the invention to be performed on the embodiment of the aforementioned configuration is described hereinbelow.

First, processing to be performed at each operation of writing image data to the HDDs is described hereinbelow. When writing image data to the HDDs 1500a to 1500d, the system controller 150 activates the HDDs by setting information on a Write command, a data amount, and addresses therein. Thus, the HDDs 1500a to 1500d start a write operation after receiving the command. Thereafter, when receiving 128-Kbyte data (namely, data having a maximum transfer data amount) from the system controller 150, each of the HDDs 1500a to 1500d sends an interrupt signal (see FIG. 10) to the system controller 150. Then, in case that there is data to be further sent to the HDDs, the system controller 150 repeats the resetting and the activation of the HDDs, so that image data is stored in the HDDs 1500a to 1500d. A transfer time t shown in FIG. 10 is a period from a time when the system controller 150 inputs the HDDs 1500 an activation command such as the Write command, a Read command used at reading image data, and the like to a time when the system controller 150 receives the interrupt signal from the HDDs 1500.

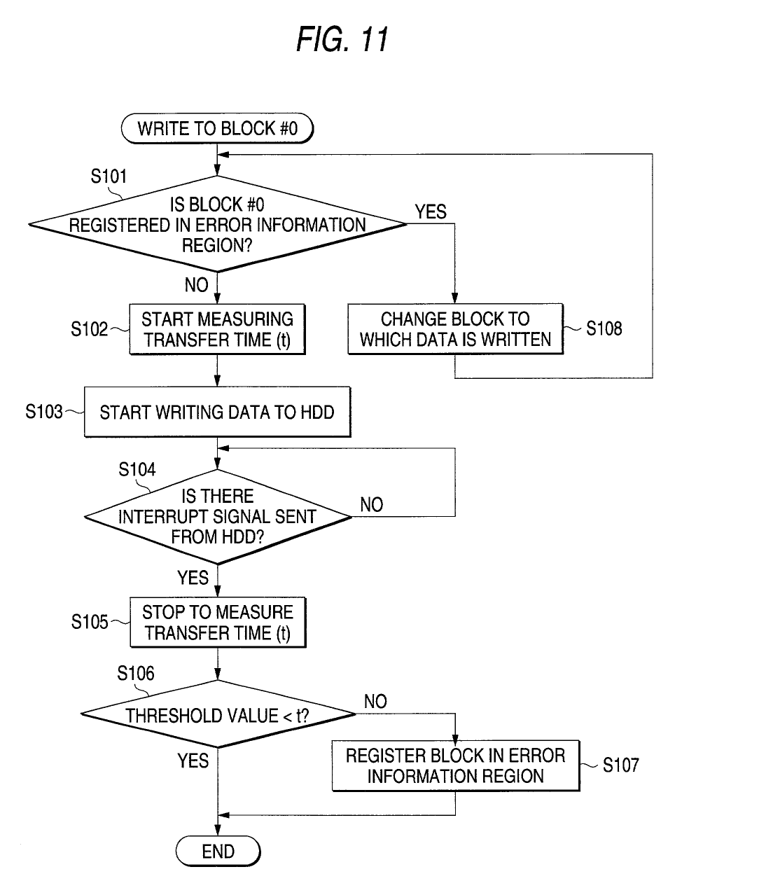

FIG. 11 is a flowchart illustrating a procedure for writing compressed image data to block #0 of the HDD shown in FIG. 6.

As shown in FIG. 10, when compressed image data is written to block #0, first, the system controller 150 decides in step S101 whether or not this block #0 is registered in the error information region 150-1b, that is, whether or not this block #0 is defective.

When a result of this decision shows in step 101 that this block #0 is not registered in the error information region 150-1b (namely, when control exits from step S101 through NO-branch), the system controller 150 subsequently starts measuring a transfer time (t) (see FIG. 10) in step S102.

Thereafter, the image data is written to the HDD 1500a to 1500d in step S103. Then, in step S104, the system controller 150 monitors whether or not an interrupt signal (see FIG. 10) is sent from the HDDs 1500a to 1500d.

When a result of this monitoring operation performed in step S104 reveals that an interrupt signal is sent from the HDDs 1500a to 1500d (namely, when control exits from step S104 through YES-branch), the system controller 150 stops measuring the transfer time (t) in step S105.

Thereafter, the system controller 150 decides in step S106 whether or not the transfer time (t) is larger than a preset threshold value, that is, whether or not this block is defective.

When a result of this decision made in step S106 shows that the transfer time (t) exceeds the threshold value, namely, that this block is defective (that is, when control exits from step S106 through YES-branch), this block is registered in the error information region 150-1b, namely, the information, which indicates that this block is defective, is registered therein. Then, this processing is finished.

On the other hand, when a result of the decision made in step S101 indicates that this block #0 is registered in the error information table, namely, this block #0 is defective (that is, when control exits from step S101 through YES-branch), the system controller 150 changes the address of the block, to which image data is written, in step S108. Subsequently, control returns to step S101. Then, those similar to the aforementioned operations are performed.

On the other hand, when a result of this decision made in step S106 shows that the transfer time (t) does not exceed the threshold value, namely, that this block #0 is normal (that is, when control exits from step S106 through NO-branch), processing is finished.

Incidentally, the threshold values referred to herein are set in view of the performance of the entire system at values that are lower than a predetermined limit so as to prevent reduction in the productivity of the apparatus. Practically, when data is written to the HDD, the threshold value is set at a proper value so as to comply with a specification relating to the number of originals read from the IIT (using a duplex automatic document feeder (DADF)) per minute. Further, when data is read from the HDD, the threshold value is set at a proper value so as to comply with a specification relating to the number of sheets that are printed out per minute.

Furthermore, there are the following practical conditions predetermined in terms of the threshold value. That is, one of such predetermined conditions is that a time taken to read data of one page of minimum image data (compressed image data) recorded in the storage region, which is obtained by dividing the storage area, is equal to or more than a time taken to form an image represented by one page of the minimum image data. Further, another of such predetermined conditions is that a time taken to read data of one page of maximum image data to be processed (compressed image data), which is recorded in the storage region obtained by dividing the storage area, is equal to or more than a time taken to form an image represented by one page of the maximum image data to be processed. Alternatively, another of such predetermined conditions is that a time taken to write data of one page of minimum image data (compressed image data) recorded in the storage region, which is obtained by dividing the storage area, is equal to or more than a time taken to form an image represented by one page of the minimum image data. Alternatively, a time taken to write data of one page of maximum image data to be processed (compressed image data) recorded in the storage region, which is obtained by dividing the storage area, is equal to or more than the time taken to form an image represented by one page of the maximum image data to be processed.

Furthermore, in addition to the aforementioned monitoring method, this embodiment may employ another monitoring method comprising the steps of: detecting places, at which defective storage unit regions are generated, and the number of the generated defective storage unit regions by obtaining information from the HDD; and inhibiting the use of the defective storage unit regions (or blocks) when the predetermined conditions are met.

In this case, the predetermined conditions may be set in terms of the number of defective storage unit regions, or in terms of a predicted value of the number of retries of access to the storage unit region.

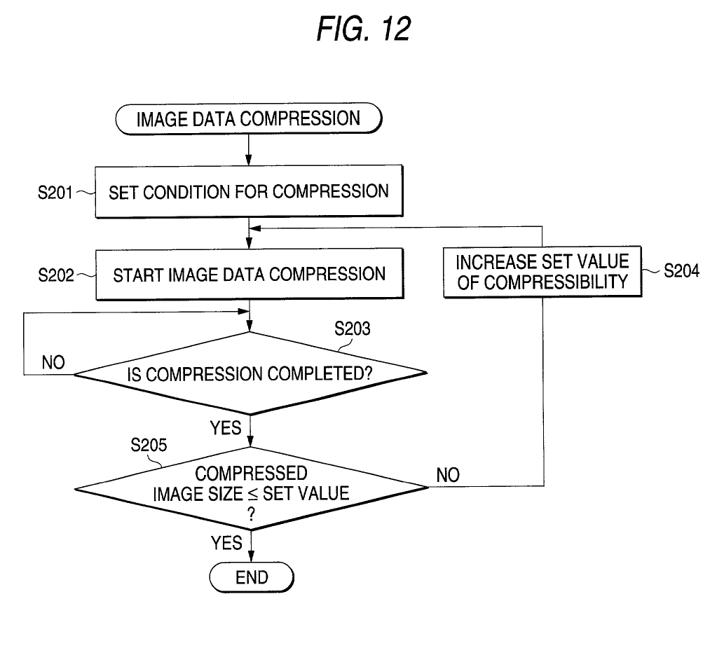

Further, FIG. 12 illustrates a procedure for performing image data compression processing so as to enable each of blocks of the HDD shown in FIG. 6 to store the image data of one page of an original.

As illustrated in FIG. 12, first, conditions for the data compression are set under control of the system controller 150 in step S201. The conditions for the data compression are, for example, setting of data size before compression, setting of compression ratio, and the like.

Thereafter, in step S202, the compression of the image data is commenced in the data compression section 151a. Upon completion of this compression (namely, when control exits from step S203 through YES-branch), subsequently, it is decided in step S205 whether or not an amount of the compressed image data corresponding to the one page of the original is equal to or less than a preset value (namely, 6 Mbytes in this embodiment), that is, whether or not data size of the compressed image data can be stored in the block.

When a result of this decision shows that the amount of the compressed data corresponding the one page of the original is more than the preset value, that is, that this compressed image data cannot be stored in the block (namely, when control exits from step S205 through NO-branch), the set value of the compressibility is increased in step S204 so that the amount of the compressed image data corresponding to the one page of the original is less than 6 Mbytes, namely, the amount of the compressed data can be stored in the block.

Incidentally, when a result of the decision made in step S205 designates that the amount of the compressed data corresponding the one page of the original is less than the preset value, namely, 6 Mbytes, that is, that this compressed image data can be stored in the block (namely, when control exits from step S205 through YES-branch), this processing is finished.

Next, a second embodiment of the invention is described hereinbelow.

Hitherto, various compression methods for such a kind of an image forming apparatus have been developed and utilized. However, techniques for automatically changing the compression method, and for automatically increasing the compressibility have been used in such apparatus mainly owing to physical causes, such as an image memory.

However, the use of such methods for processing image data results in occurrence of a drawback in that the processing finishes without obtaining high image quality as a user intends.

The functions of such methods are disadvantageous for obtaining high image quality by using such image forming apparatus. Thus, the processing is performed only by giving priority to machine convenience.

For example, in a case of an apparatus disclosed in JP-A-9-216349, when an amount of image data having undergone reversible compression exceeds a predetermined value, irreversible compression is performed at the same resolution. That is, this results in deterioration in image quality of a formed image. Therefore, a processing apparatus performs the processing without taking user convenience into account.

Incidentally, although JP-A-9-216349 describes that a compression method is fixed by giving priority to the image quality of a formed image or to the efficiency in performing the processing, the processing is performed in such a case by changing the resolution. Thus, finally, degradation in the image quality thereof occurs.

Similarly, in a case of an apparatus disclosed in JPA-11-165434, reduction/enlargement processing is automatically performed by selecting a compression method, by which the most appropriate processing speed is provided, according to an image to be processed. However, there is a possibility that degradation in image quality of a formed image occurs contrary to a user's intention.

Although the apparatus disclosed in these official gazettes are created to eliminate physical limitations, these apparatus disregard a user's intention of obtaining high image quality.

Thus, according to the invention, when data representing conditions for giving priority to high image quality or processing speed is inputted by a user through an input section, the image data is not compressed or reversible compression is performed on the image data in case that the user gives priority to high image quality. In contrast, in case that the user gives priority to a processing speed, another compression method using irreversible compression or conventional techniques is employed.

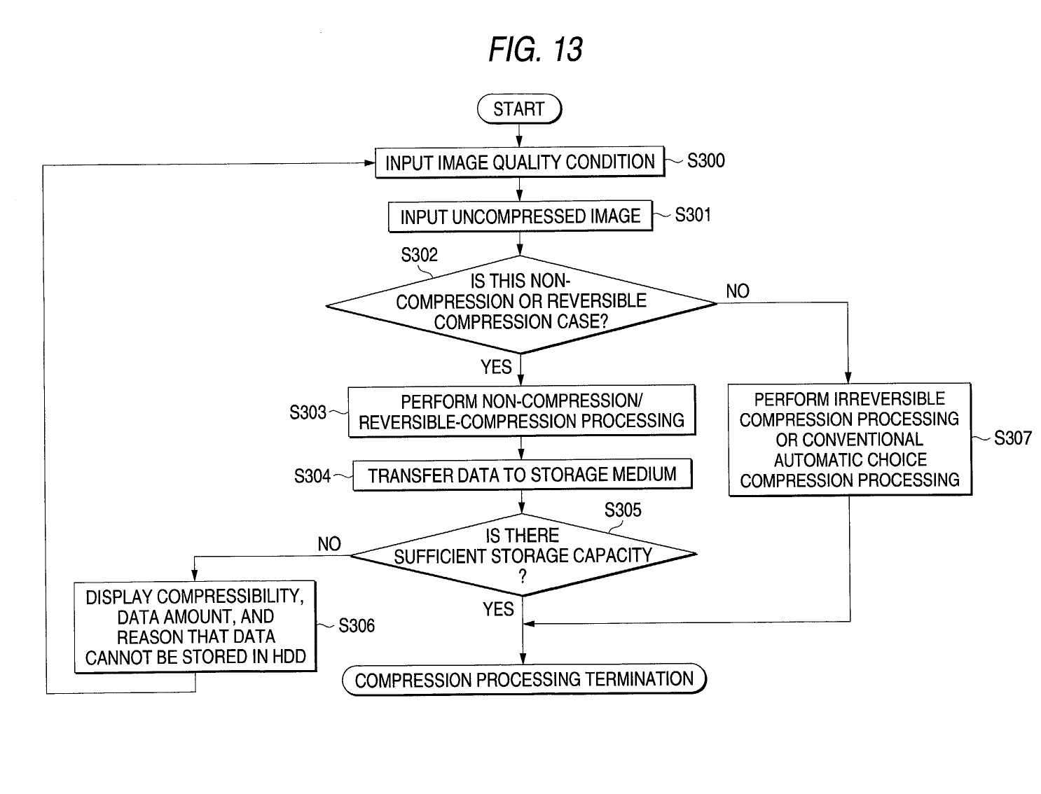

FIG. 13 illustrates a procedure for performing such a compression method according to the invention.

As shown in FIG. 13, at first, the user inputs a image quality condition by a image quality condition inputting section (not shown) in step S300. The image quality condition includes at least whether or not high image quality is required. When the image quality condition is inputted in step S300, the image data, which is not compressed yet, is inputted in step S301. Then, it is decided in step S302 whether or not reversible compression is performed, that is, whether or not a user requests high image quality. The image quality condition inputting section may be the same section as a copy condition inputting section by which in a case of performing copying operation ((1)+(2) as shown in FIG. 2), the user inputs size of a paper, the number of copies, and the like. In this case, when the user inputs the copy condition and the image quality condition, and press a start button, the compression process proceeds from step S300 to step S301. In this embodiment, the image data, which is not compressed yet, is inputted from the image input terminal (IIT) or is inputted from the client terminal (PC) 400 through the network 300.

When a result of the decision made in the step S302 reveals that the image data is not compressed or reversible compression is performed thereon, namely, that the user requests high image quality (that is, when control exits from step S302 through YES-branch), the image data is not compressed, or reversible compression is performed thereon in step S303. Subsequently, the non-compressed image data or the image data compressed by reversible compression is transferred to the HDD in step S304.

Thereafter, it is decided in step S305 whether or not all the image data can be stored in the HDD.

When a result of this decision made in step S305 shows that the image data can be stored in the HDD (that is, when control exits from step S305 through YES-branch), this processing is finished.

Conversely, when a result of this decision made in step S305 shows that all the image data cannot be stored in the HDD (that is, when control exits from step S305 through NO-branch), the compressibility and the amount of the image data are indicated on a screen of a display portion in step S306. Thus, the apparatus presents a user the reason why the image data is not stored in the HDD. Then, the control proceeds to step S300 to re-input the image quality condition thereby enabling the image data to be stored in HDD. In this re-inputting process, inputting uncompressed image in step S301 is skipped.

Furthermore, conversely, when a result of this decision made in step S302 shows that reversible compression is not performed, namely, that the user does not request high image quality (that is, when control exits from step S302 through NO-branch), irreversible compression processing or the conventional automatic choice compression processing is performed in step S307. Subsequently, this processing is finished. The compression processing shown in FIG. 12 may be performed as the irreversible compression processing in step S307.

With this configuration, the image quality of an image is prevented from being deteriorated contrary to a user's intention. Moreover, this enables the apparatus to show the physical limitations to users. Consequently, this permits users to perform image processing by interacting with the apparatus.

Incidentally, practically, it is decided in step S305 whether or not the amount of the image data is equal to or less than the amount of image data corresponding to one page of the minimum image data secured in the hard disk (HDD), or whether or not the amount of the image data is equal to or less than the amount of image data corresponding to one page of the maximum image data to be processed, which is secured in the hard disk (HDD). Additionally, when the physical storage area of the hard disk (HDD) is insufficient for storing the image data, it is decided in this step that the image data cannot be stored in the HDD. In step S305, the amount of one page of the minimum image data is determined in accordance with size of the image at image formation, such as A4, B5, and the like, and the image quality required for image at image formation.

Further, the reversible compression (to be performed by default) may be selected when the compressed image data is simply printed by being expanded. Furthermore, the method of performing no compression on the image data may be selected when the image data is sent to the client terminal 400 through the network 300 and then edited therein (during the scan-to-file operation).

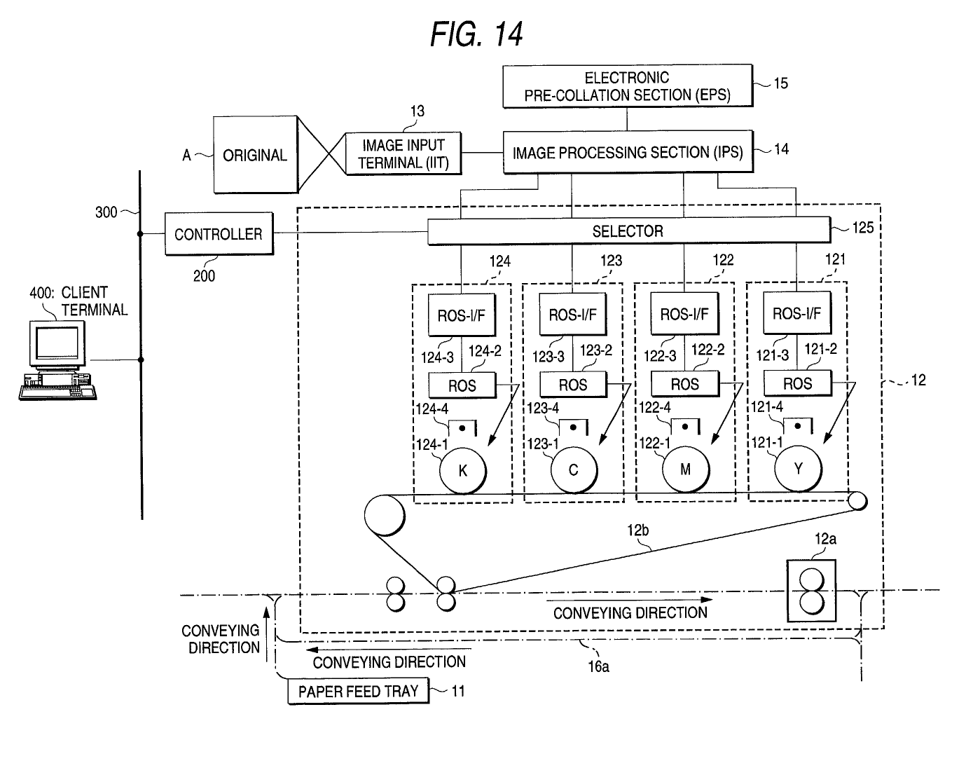

Additionally, the configuration of the tandem color image forming apparatus of the invention is not limited to that illustrated in FIG. 1. As shown in FIG. 14, the apparatus may be adapted so that the image output terminal (IOT) has the intermediate transfer medium 12b, and that the transfer of a toner image to a paper through this intermediate transfer medium 12b is performed.

Further, although FIGS. 1 and 14 show the tandem color image forming apparatuses adapted to form images by using the photosensitive drums, the invention is not limited thereto. The invention may be applied to, for example, an image forming apparatus having image forming section, such as an ink jet.

As described above, according to an aspect of the invention, there is provided a storage medium control apparatus comprising a control section adapted to control a data writing/reading operation to/from a storage medium, wherein the storage medium is divided into a plurality of storage regions each having a predetermined storage amount; the control section defines a plurality of units of management, by each of which the data writing/reading operation is performed; each of units of management has predetermined number of the storage regions being sequential physically; and a storage amount of the predetermined number of the storage regions is an amount of predetermined data to be stored physically-sequentially in the storage medium. This configuration enables the apparatus to control the data writing/reading operations by employing each of the plurality of physically sequential storage regions as the unit of management.

Further, according to another aspect of the invention, there is provided an image forming apparatus comprising a control section adapted to control an image data writing/reading operation to/from a storage medium, wherein the storage medium is divided into a plurality of storage regions each having a predetermined storage amount; the control section defines a plurality of units of management, by each of which the image data writing/reading operation is performed; each of units of management has predetermined number of the storage regions being sequential physically; and a storage amount of the predetermined number of the storage regions is an amount of predetermined image data to be stored physically-sequentially in the storage medium. This enables the image forming apparatus to perform the image data writing/reading operations on the units of management by units of the predetermined image data. Thus, an amount of the predetermined image data is necessarily stored in the units of management, that is, the plurality of physically sequential regioins. Consequently, a data transfer time at each data write/read is stabilized.

Moreover, according to another aspect of the invention, there is provided the image forming apparatus according to the above described, further comprising: an image inputting section adapted to input an image data before compressed; an compression condition inputting section for adapted to input a compression condition by an user; and a compression control section adapted to apply compression processing to the image data before compressed on a basis of the compression condition, wherein the compression-processed image data is written to the storage medium. Thus, the image quality of an image is prevented from being deteriorated contrary to a user's intention.

What is claimed is:

1. A storage medium control apparatus comprising a control section adapted to control a data writing/reading operation to/from a storage medium,
wherein the storage medium is divided into a plurality of storage regions each having a predetermined storage amount;
the control section defines a plurality of units of management, by each of which the data writing/reading operation is performed;
each of units of management has predetermined number of the storage regions being sequential physically; and
a storage amount of the predetermined number of the storage regions is an amount of predetermined data to be stored physically-sequentially in the storage medium.

2. The storage medium control apparatus according to claim 1, wherein when a defective storage region is detected from one of the units of management, the control section inhibits use of the one of the units of management.

3. The storage medium control apparatus according to claim 1, wherein when a time taken to write/read data to/from one of storage units of management is not shorter than a predetermined time, the control section inhibits use of the one of the units of management.

4. The storage medium control apparatus according to claim 1, wherein the storage medium is a disk; and
the storage regions are sectors.

5. An image forming apparatus comprising a control section adapted to control an image data writing/reading operation to/from a storage medium,
wherein the storage medium is divided into a plurality of storage regions each having a predetermined storage amount;
the control section defines a plurality of units of management, by each of which the image data writing/reading operation is performed;
each of units of management has predetermined number of the storage regions being sequential physically; and
a storage amount of the predetermined number of the storage regions is an amount of predetermined image data to be stored physically-sequentially in the storage medium.

6. The image forming apparatus according to claim 5, wherein the predetermined image data is one page of a minimum image data.

7. The image forming apparatus according to claim 5, wherein the predetermined image data is one page of a maximum image data being handled.

8. The image forming apparatus according to claim 5, further comprising a monitoring section adapted to monitor a status of generation of a defective storage regions in each of units of management.

9. The image forming apparatus according to claim 8, the monitoring section obtains the status of generation of defective storage regions in each of units of management from the storage medium to perform monitoring.

10. The image forming apparatus according to claim 8, wherein when the status of generation of defective storage regions in one of the units of management meets a predetermined condition, the control section inhibits use of the one of the units of management.

11. The image forming apparatus according to claim 10, wherein the predetermined condition is that the number of the defective regions in the one of the units of management is not smaller than a predetermined number.

12. The image forming apparatus according to claim 10, wherein the predetermined condition is that the number of times of retry accesses to the one of the units of management is not smaller than a predetermined number of times.

13. The image forming apparatus according to claim 10, wherein the predetermined condition is that one of a time taken to read the image data from the one of the units of management and a time take to write the image data from the one of the units of management is not shorter than a predetermined time.

14. The image forming apparatus according to claim 13, further comprising an image forming section adapted to form an image on a paper based on the image data,
wherein the predetermined time is a time taken to form the image on the paper by the image forming section.

15. The image forming apparatus according to claim 5, wherein the storage medium is a hard disk; and
the storage region is a sector.

16. The image forming apparatus according to claim 5, further comprising:
an image inputting section adapted to input an image data before compressed;
an image quality condition inputting section for adapted to input image quality condition including high image quality condition; and
a compression control section adapted to apply compression processing, which includes non-compression, to the image data before compressed on a basis of the image quality condition,
wherein the compression-processed image data is written to the storage medium; and
in case of the high image quality condition, the compression control section performs non-compression or reversible-compression.

17. The image forming apparatus according to claim 16, further comprising a notifying section adapted to notify the user of information,
wherein when an amount of the compressed image data is not smaller than a predetermined amount, the notifying section notifies the user of the amount of the compressed image data being not smaller than the predetermined amount.

18. The image forming apparatus according to claim 17, wherein the predetermined amount is an amount of one page of a minimum image data.

19. The image forming apparatus according to claim 17, wherein the predetermined amount is an amount of one page of a maximum image data to be handled.

20. The image forming apparatus according to claim 17, wherein the predetermined amount is a remaining amount of the storage medium.

21. A storage medium control method for controlling data writing/reading operations to/from a storage medium adapted to store data by units of storage regions having a predetermined storage amount, the method comprising the steps of:
defining a plurality of units of management having predetermined number of the storage regions being sequential physically; and
performing the data writing/reading operation by the units of management,
wherein an amount of the predetermined number of the storage regions is an amount of predetermined data to be stored physically-sequentially in the storage medium.

22. An image forming apparatus control method for controlling image data writing/reading operations to/from a storage medium adapted to store data by units of storage regions having a predetermined storage amount, the method comprising the steps of:
defining a plurality of units of management having predetermined number of the storage regions being sequential physically; and
performing the data writing/reading operation by the units of management,
wherein an amount of the predetermined number of the storage regions is an amount of predetermined image data to be stored physically-sequentially in the storage medium.

23. The method according to claim 22, wherein the predetermined image data is one page of a minimum image data.

24. The method according to claim 22, further comprising the steps of:
inputting image data before compressed;
inputting a compression condition;
applying compression process to the image data before compressed on a basis of the compression condition; and
storing the compressed image data in the storage medium.

25. An image forming apparatus for converting image data obtained by reading with an image reading section into a plurality of image data consisting of a plurality of colors and for performing image formation, the image forming apparatus comprising a compression control section, in case that the image formation with high image quality is instructed, adapted to non-compressing or reversibly compressing the image data obtained by reading the image reading section to save the non-compressed or reversibly compressed image data in a record medium.

26. The image forming apparatus according to claim 25, further comprising a notifying section adapted to notify a reason in case that the image data by the compression control section is larger than a predetermined amount.
